(19) United States
(12) Patent Application Publication
(10) Pub. No.: US 2024/0318816 A1
(43) Pub. Date: Sep. 26, 2024

(54) INLET NOZZLE ASSEMBLY FOR AN ABATEMENT APPARATUS

(71) Applicant: Edwards Limited, Burgess Hill, Sussex (GB)

(72) Inventor: Andrew James Seeley, Clevedon, Somerset (GB)

(21) Appl. No.: 18/577,906

(22) PCT Filed: Jul. 7, 2022
(86) PCT No.: PCT/GB2022/051749

§ 371 Date: Jan. 9, 2024

(30) Foreign Application Priority Data
Jul. 13, 2021 (GB) 2110053.2

(51) Int. Cl. F23G 7/06; B01D 53/70; F23D 14/58

(52) U.S. Cl. CPC F23G 7/065; B01D 53/70; F23D 14/58; B01D 2257/2066; B01D 2258/0216; F23G 2209/142; F23G 2900/54402

(57) ABSTRACT

An inlet nozzle assembly, an abatement apparatus and a method are disclosed. The inlet nozzle assembly is for an abatement apparatus for treating an effluent stream from a semiconductor processing tool, the inlet nozzle assembly comprises: an inlet nozzle configured to deliver the effluent stream into an abatement chamber; a head defining an aperture for receiving the inlet nozzle; and an insulating mount configured to retain the inlet nozzle within the aperture. In this way, the thermal path between the inlet nozzle and the head is interrupted by the insulating mount which helps to prevent the inlet nozzle being cooled by the head, which helps to prevent condensates gathering as powder or particulates on the inlet nozzle.

### CROSS-REFERENCE OF RELATED APPLICATION

This application is a Section 371 National Stage Application of International Application No. PCT/GB2022/051749, filed Jul. 7, 2022, and published as WO 2023/285783A1 on Jan. 19, 2023, the content of which is hereby incorporated by reference in its entirety and which claims priority of British Application No. 2110053.2, filed Jul. 13, 2021.

### FIELD

The field of the invention relates to an inlet nozzle assembly, an abatement apparatus and a method.

### BACKGROUND

Abatement apparatus, such as radiant burners or other types of abatement apparatus, are known and are typically used for treating an effluent gas stream from a manufacturing processing tool used in, for example, the semiconductor or flat panel display manufacturing industry. During such manufacturing, residual perfluorinated compounds (PFCs) and other compounds exist in the effluent gas stream pumped from the process tool. PFCs are difficult to remove from the effluent gas and their release into the environment is undesirable because they are known to have relatively high greenhouse activity.

Known radiant burners use combustion to remove the PFCs and other compounds from the effluent gas stream, such as that described in EP 0 694 735. Typically, the effluent gas stream is a nitrogen stream containing PFCs and other compounds. The effluent stream is conveyed into a combustion chamber that is laterally surrounded by the exit surface of a foraminous gas burner. In some cases treatment materials, such as fuel gas, can be mixed with the effluent gas stream before entering the combustion chamber. Fuel gas and air are simultaneously supplied to the foraminous burner to affect combustion at the exit surface. The products of combustion from the foraminous burner react with the effluent stream mixture to combust compounds in the effluent stream.

Although arrangements of abatement apparatus exist, they each have their own shortcomings. Accordingly, it is desired to provide an improved arrangement for abatement apparatus.

The discussion above is merely provided for general background information and is not intended to be used as an aid in determining the scope of the claimed subject matter. The claimed subject matter is not limited to implementations that solve any or all disadvantages noted in the background.

### SUMMARY

According to a first aspect, there is provided an inlet nozzle assembly for an abatement apparatus for treating an effluent stream from a semiconductor processing tool, the inlet nozzle assembly comprising: an inlet nozzle configured to deliver the effluent stream into an abatement chamber; a head defining an aperture for receiving the inlet nozzle; and an insulating mount configured to retain the inlet nozzle within the aperture.

The first aspect recognizes that a problem with existing inlet assemblies is that the operational life of the assembly can be poor, which impacts the performance and decreases the time between maintenance periods. In particular, particulates or powder can accumulate on the inlet nozzle assembly, which can affect fluid flow and even lead to blockages.

Accordingly, an inlet nozzle assembly is provided. The inlet nozzle assembly may be for an abatement apparatus. The abatement apparatus may treat an effluent stream from a semiconductor processing tool. The inlet assembly may comprise an inlet nozzle. The inlet nozzle may be configured to deliver or convey the effluent stream into an abatement chamber. The inlet nozzle assembly may comprise a head. The head may define an aperture which receives the inlet nozzle. The inlet nozzle assembly may comprise an insulating mount. The insulating mount may be configured or arranged to retain the inlet nozzle within the aperture. In this way, the thermal path between the inlet nozzle and the head is interrupted by the insulating mount which helps to prevent the inlet nozzle being cooled by the head, which helps to prevent condensable materials forming deposits on cooler parts of the inlet nozzle.

The insulating mount may be configured to surround or encompass the inlet nozzle. The insulating mount may be interposed or positioned between the inlet nozzle and the head.

The insulating mount may be configured or arranged to space or position the inlet nozzle away from the head. Spacing away from the head helps to inhibit the thermal path.

The insulating mount may comprise a plurality of protrusions, members or fingers configured or arranged to contact with the inlet nozzle. Providing protrusions helps to decrease the contact area which helps to inhibit the thermal path.

The protrusions may extend from a facing surface of the insulating mount to space or position the inlet nozzle away from the facing surface.

The insulating mount may define a purge conduit. The purge conduit may be configured or arranged to convey or deliver a purge gas from a purge gas feed to a purge gas plenum in the head. Hence, the insulating mount may be dual purpose.

The inlet nozzle may comprise an effluent stream nozzle for delivery or to convey the effluent stream. The inlet nozzle may also comprise a concentric combustion reagent nozzle for delivery or conveying of combustion reagents. The insulating mount may define a combustion reagent conduit. The combustion reagent conduit may be configured to convey or deliver combustion reagents from a combustion reagent feed to the concentric combustion reagent nozzle.

The concentric combustion reagent nozzle may surround the effluent stream nozzle.

The inlet nozzle may comprise an upstream inlet portion. The upstream inlet portion may define an inlet chamber. The inlet chamber may receive the effluent stream. The inlet nozzle may comprise a downstream delivery portion. The downstream delivery portion may define a delivery chamber. The delivery chamber may deliver or convey the effluent stream into the abatement chamber. The upstream inlet portion may be configured to be spaced or positioned away from the head. Spacing away from the head helps to inhibit the thermal path.

The upstream inlet portion may be configured to be spaced or positioned away from the head by the insulating mount.

The upstream inlet portion may be configured or arranged to be spaced or positioned away from an upstream surface of the head.

The insulating mount may comprise a heat insulating material.

The insulating mount may have a lower thermal conductivity than the inlet nozzle and/or the head.

According to a second aspect, there is provided an abatement apparatus comprising the inlet nozzle assembly of the first aspect.

The abatement apparatus may comprise the features of the inlet nozzle assembly set out above.

According to a third aspect, there is provided a method, comprising: defining an aperture in a head for receiving an inlet nozzle for delivering an effluent stream into an abatement chamber; and retaining the inlet nozzle for within the aperture with an insulating mount.

The method may comprise surrounding the inlet nozzle with the insulating mount.

The method may comprise interposing the insulating mount between the inlet nozzle and the head.

The method may comprise spacing the inlet nozzle away from the head with the insulating mount.

The method may comprise contacting the inlet nozzle with a plurality of protrusions of the insulating mount.

The method may comprise extending the protrusions from a facing surface of insulating mount to space the inlet nozzle away from the facing surface.

The method may comprise defining a purge conduit in the mount configured to convey a purge gas from a purge gas feed to a purge gas plenum in the head.

The method may comprise providing the inlet nozzle with an effluent stream nozzle for delivery of the effluent stream and a concentric combustion reagent nozzle for delivery of combustion reagents and defining a combustion reagent conduit with the configured to convey combustion reagents from a combustion reagents feed to the concentric combustion reagent nozzle.

The method may comprise surrounding the effluent stream nozzle with the concentric combustion reagent nozzle.

The method may comprise defining an inlet chamber for receiving the effluent stream with an upstream inlet portion of the inlet nozzle and a delivery chamber for delivery of the effluent stream into the abatement chamber with a downstream delivery portion of the inlet nozzle and spacing the upstream inlet portion away from the head.

The method may comprise spacing the upstream inlet portion away from the head with the insulating mount.

The method may comprise spacing the upstream inlet portion away from an upstream surface of the head.

The method may comprise forming the insulating mount from a heat-insulating material.

The method may comprise selecting the insulating mount to have a lower thermal conductivity than at least one of the inlet nozzle and the head.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

The Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

Embodiments of the present invention will now be described further, with reference to the accompanying drawings, in which:

FIG. 1 is a front cross-section through an inlet assembly for an abatement apparatus, according to one embodiment;

FIG. 2 is a side cross-section through the inlet assembly of FIG. 1;

FIG. 3 is an exploded perspective view of the front cross-section through the inlet assembly of FIG. 1;

FIG. 4 is a front cross-section through an inlet assembly for an abatement apparatus, according to one embodiment; and

FIG. 5 is an perspective view of the front cross-section through the inlet assembly of FIG. 4.

### DETAILED DESCRIPTION

Before discussing embodiments in any more detail, first an overview will be provided. Some embodiments provide an arrangement which thermally insulates an effluent stream inlet nozzle (and typically a reagent inlet nozzle) from a mount or a head in order to reduce the cooling effects of that mount or head on the inlet nozzle to help prevent the build-up of condensate, powder or particulates on the inlet nozzle. In particular, the head or mount typically has a high thermal mass which would otherwise tend to cool the inlet nozzle which can cause compounds in the effluent stream to condense in the vicinity of the inlet nozzle, which causes build-up of particulate material or powder which can affect fluid flow within the inlet nozzle and/or the downstream combustion chamber and/or can lead to bridging or blockages which affects the performance of the abatement apparatus. Providing an insulating mount which interrupts or reduces the thermal path between the inlet nozzle and the head or mount helps to reduce the cooling effects of the head or mount on the inlet nozzle. Typically, the insulating mount is formed of a thermally insulating material which has a thermal conductivity which is lower than that of the effluent stream inlet and/or the head or mount. Furthermore, the insulating mount is typically shaped or dimensioned to space components of the inlet nozzle away from the head or mount in order to avoid direct contact between these and/or to reduce the contact area between these components and the insulating mount.

### Inlet Assembly—1^{st} Arrangement

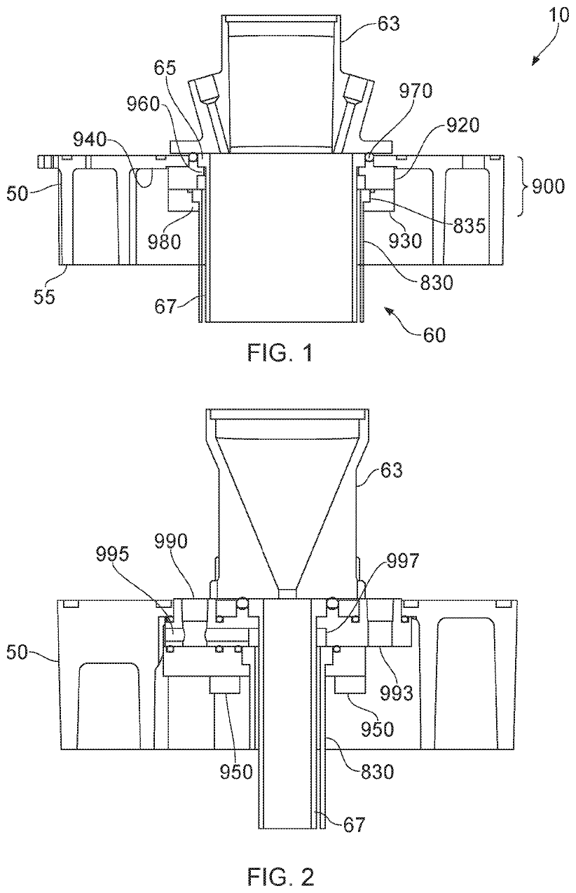

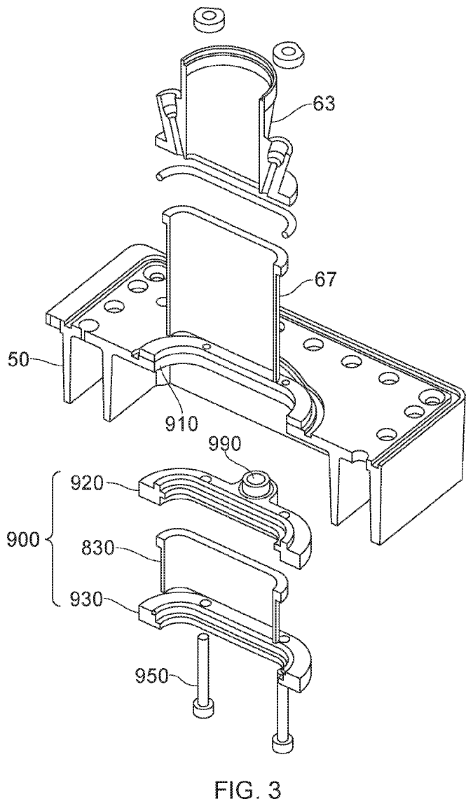

FIG. 1 is a front cross-section through an inlet assembly for an abatement apparatus 10, according to one embodiment. FIG. 2 is a side cross-section through the inlet assembly. FIG. 3 is an exploded perspective view of the front cross-section through the inlet assembly. A mount 50 is provided which attaches on its downstream surface 55 with a housing (not shown) of a combustion chamber module. The combustion chamber module typically contains a foraminous sleeve housed within the housing. The foraminous sleeve within the housing defines a combustion chamber. The mount 50 defines an inlet aperture 910 which receives an inlet nozzle 60. In this embodiment, the inlet nozzle 60 has an obround cross-section. However, it will be appreciated that other shape inlet nozzles 60 are possible, such as those with circular or other cross-sections. The inlet nozzle 60 has an upstream inlet portion 63 which attaches with a source of the effluent stream and a downstream delivery portion 67 which delivers the effluent stream into the combustion chamber.

An insulating mount 900 is located within the inlet aperture 910. The insulating mount is made of a lower thermal conductivity material than the inlet nozzle 60 and/or the mount 50. The insulating mount 900 has an upstream portion 920 and a downstream portion 930. The upstream portion 920 abuts an upstream ceiling 940 of the mount 50. The insulating mount 900 is retained in place against the upstream ceiling 940 by fixings 950. The upstream portion 920 defines an upstream retaining rim 960 which extends radially within the aperture 910. The upstream portion 920 is potentially process-wetted so typically has chemical compatibility and may be made from filled PTFE (glass-filled or mica-filled) with operating temperatures of up to 260° C. The downstream portion 930 does not require chemical compatibility and may be made from a polyamide-imide (PAI) or polyether ether ketone (PEEK). The retaining rim 960 cooperates with a radially extending flange 65 on the delivery portion 67 to retain the inlet nozzle 60 in place within the mount 50. An annular protrusion 970 upstanding from an upstream surface of the upstream portion 920 spaces the radially outer surface of the delivery portion 67 away from the radially inner surface of the aperture 910. In addition, the delivery portion 67 and the insulating mount 900 are dimensioned to prevent contact between the downstream surface of the inlet portion 63 and the upstream surface of the mount 50. In other words, the inlet portion is slightly elevated to provide a gap between the inlet portion 63 and the mount 50.

Hence, it can be seen that the insulating mount 900 prevents contact between the inlet nozzle 60 and the mount 50, with low thermal conductivity material being interposed between the inlet nozzle 60 and the mount 50. This helps to impair the thermal path between the inlet nozzle 60 and the mount 50 which helps to prevent cooling of the inlet nozzle 60 by the mount 50 and reduces the build-up of condensate on the inlet nozzle 60.

The downstream portion 930 also has a radially extending upstream retaining rim 980 which receives a radially extending flange 835 on an upstream end of a reagent nozzle 830 (which extends to an exhaust of the delivery portion 67) that surrounds an outer surface of a portion of the delivery portion 67. This spaces the reagent nozzle 830 away from the inlet nozzle 60 and prevents contact between the reagent nozzle 830 and the mount 50, with low thermal conductivity material being interposed between the reagent nozzle 830 and the mount 50. This helps to impair the thermal path between the reagent nozzle 830 and the mount 50 which helps to prevent cooling of the reagent nozzle 830 by the mount 50 and reduces the build-up of condensate on the reagent nozzle 830.

The insulating mount 900 has a reagent inlet 990 which receives a reagent and conveys this via a reagent conduit 995 to an annular gallery 997 which is in fluid communication with an upstream end of the reagent nozzle 830. Hence, any reagent to be supplied to the combustion chamber is conveyed through the insulating mount 900 to the reagent nozzle 830 for delivery into the combustion chamber, surrounding the effluent stream.

The insulating mount 900 has a purge inlet 993 which receives a purge gas and conveys this into the mount 50 to provide a positive pressure within the mount 50 using an inert gas to prevent the backflow of gases into the mount 50.

### Inlet Assembly—2^{nd} Arrangement

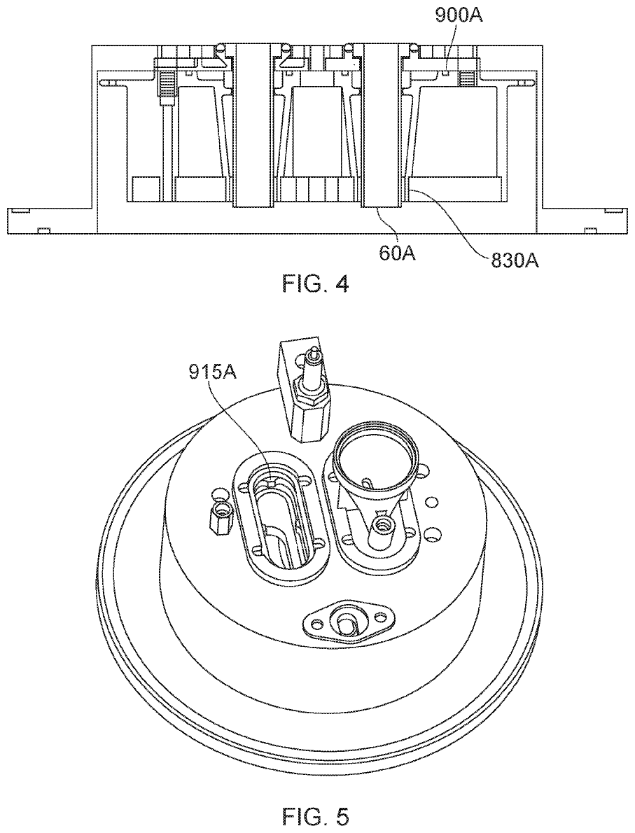

FIGS. 4 and 5 illustrate an inlet assembly for an abatement apparatus 10A according to one embodiment which is similar to the arrangement described above. In this arrangement, an insulating mount 900A is provided which receives an inlet nozzle 60A and supports a concentric reagent nozzle 830A. In this arrangement, the insulating mount 900A has a set of protrusions 915A which contact with the inlet nozzle 60A and space this away from the insulating mount 900A, to further reduce the contact between the inlet nozzle 60A and the insulating mount 900A in order to further impair the thermal path. It will be appreciated that similar protrusions could be incorporated into the arrangement described with reference to FIGS. 1 to 3 above.

Some embodiments provide an arrangement for reducing heat transfer between an inlet system and the head of a thermal/combustion abatement system to minimise deposition of condensable by-products. In such thermal/combustion-based abatement systems, gases to be treated generally enter the combustion chamber via one or more nozzles surmounted by an inlet assembly. Some assemblies may comprise flow conditioning devices and/or auxiliary inlets. Some processes for example aluminium etch, LPCVD nitride, PECVD nitride, may produce condensable by-products such as AlCl3, NH4Cl and (NH4)2SiF6. The nozzles generally rests in a register in the head or mount, likewise the inlet structure is typically fixed to the head or mount. Thus, if the inlet structures are in mechanical and hence thermal contact with the head or mount, which can act as a heat sink, this can cool these structures to a point where condensation can occur. Hence, in some embodiments the head is designed to minimise the thermal contact with the nozzle(s). In some embodiments, separate register features, constructed from materials of a lowest thermal conductivity, are provided. In some embodiments, register features are modified to reduce the contact with the nozzle. In some embodiments, a combination of a lowest thermal conductivity insulating mount and long thermal path is employed to increase the overall resistance to heat transfer. The inlet assembly is typically designed to have no direct contact with the head, instead being located within a locater and retained with retainers of the insulating mount. The mating face of the inlet assembly bears on an elastomer for sealing and directly to the top face of the nozzle to limit the compression of the elastomer seal. Ordinarily, the nozzle is made from a corrosion resistant material such as Inconel 600 or ANC16 both of which have comparatively lower thermal conductivity than other nozzle materials (although these materials still have a higher thermal conductivity than the insulating mount). The temperature of the inlet may be further increased by substituting a nozzle of higher thermal conductivity, for example copper. This nozzle may be joined to the inlet assembly, for example by brazing. The nozzle may be protected from corrosion by plating, for example electroless nickel plating. The plating thickness may be between 25 μm and 75 μm, for example 50 μm.

Although illustrative embodiments of the invention have been disclosed in detail herein, with reference to the accompanying drawings, it is understood that the invention is not limited to the precise embodiment and that various changes and modifications can be effected therein by one skilled in the art without departing from the scope of the invention as defined by the appended claims and their equivalents.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. An inlet nozzle assembly for an abatement apparatus for treating an effluent stream from a semiconductor processing tool, said inlet nozzle assembly comprising:
an inlet nozzle configured to deliver said effluent stream into an abatement chamber;
a head defining an aperture for receiving said inlet nozzle; and
an insulating mount configured to retain said inlet nozzle within said aperture.

2. The inlet nozzle assembly of claim 1, wherein said insulating mount at least one of configured to surround said inlet nozzle and interposed between said inlet nozzle and said head.

3. The inlet nozzle assembly of claim 1, wherein said insulating mount is configured to space said inlet nozzle away from said head.

4. The inlet nozzle assembly of claim 1, wherein said insulating mount comprises a plurality of protrusions configured to contact with said inlet nozzle.

5. The inlet nozzle assembly of claim 4, wherein said protrusions extend from a facing surface of insulating mount to space said inlet nozzle away from said facing surface.

6. The inlet nozzle assembly of claim 1, wherein said insulating mount defines a purge conduit configured to convey a purge gas from a purge gas feed to a purge gas plenum in said head.

7. The inlet nozzle assembly of claim 1, wherein said inlet nozzle comprises an effluent stream nozzle for delivery of said effluent stream and a concentric combustion reagent nozzle for delivery of combustion reagents and said insulating mount defines a combustion reagent conduit configured to convey combustion reagents from a combustion reagents feed to said concentric combustion reagent nozzle.

8. The inlet nozzle assembly of claim 7, wherein said concentric combustion reagent nozzle surrounds said effluent stream nozzle.

9. The inlet nozzle assembly of claim 1, wherein said inlet nozzle comprises an upstream inlet portion defining an inlet chamber for receiving said effluent stream and a downstream delivery portion defining a delivery chamber for delivery of said effluent stream into said abatement chamber, wherein said upstream inlet portion is configured to be spaced away from said head.

10. The inlet nozzle assembly of claim 9, wherein said upstream inlet portion is configured to be spaced away from said head by said insulating mount.

11. The inlet nozzle assembly of claim 9, wherein said upstream inlet portion is configured to be spaced away from an upstream surface of said head.

12. The inlet nozzle assembly of claim 1, wherein said insulating mount comprises a heat-insulating material.

13. The inlet nozzle assembly of claim 1, wherein said insulating mount has a lower thermal conductivity than at least one of said inlet nozzle and said head.

14. An abatement apparatus comprising the inlet nozzle assembly of claim 1.

15. A method, comprising:
defining an aperture in a head for receiving an inlet nozzle for delivering an effluent stream into an abatement chamber; and
retaining said inlet nozzle for within said aperture with an insulating mount.
